(19) United States
(12) Patent Application Publication
(10) Pub. No.: US 2026/0215395 A1
(43) Pub. Date: Jul. 30, 2026

(54) PET FEEDER WITH PET MICROCHIP IDENTIFICATION FOR ACCESS CONTROL AND METHOD OF OPERATION

(71) Applicant: America Leader Electric Appliance, Inc., Schaumberg, IL (US)

(72) Inventor: Lei Zhang, Schaumberg, IL (US)

(73) Assignee: America Leader Electric Appliance, Inc., Schaumberg, IL (US)

(21) Appl. No.: 19/460,251

(22) Filed: Jan. 26, 2026

Related U.S. Application Data
(60) Provisional application No. 63/749,355, filed on Jan. 24, 2025.

(51) Int. Cl. A01K 5/02; G06K 7/10

(52) U.S. Cl. CPC A01K 5/025; A01K 5/0208; G06K 7/10297

(57) ABSTRACT

The present disclosure relates to an automated animal or pet feeder which has an integrated food hopper and automated food dispensing mechanism which can periodically dispense portioned food over a period of several days or weeks. The feeder incorporates a highly sensitive RFID microchip antenna which can sense either external tag microchips or microchips implanted directly within the animal itself. A unique open mode operation maintains the feeder door normally open to allow a specific authorized animal unrestricted access to food in the dispenser but will close the door if a tagged, but unauthorized, animal approaches the feeder.

### CROSS REFERENCE TO RELATED APPLICATIONS

This application is a non-provisional filing of, and claims the benefit of, U.S. Provisional Patent Application No. 63/749,355, filed Jan. 24, 2025, the entire contents of which are incorporated herein by reference.

### BACKGROUND OF THE DISCLOSURE

### (1) Field of the Invention

The instant invention generally relates to animal or pet feeders, and methods of operating the feeder in different modes.

### (2) Description of Related Art

As technology progresses and pet care arrangements evolve, there is a changing need for improved pet feeder devices with more automated features. Some animal feeders may have a housing with an aperture for a feed bowl and a door mechanism to control movement of the door over the aperture and sensors to detect when an animal has moved towards or away from the aperture. Some animal feeders may have automated dispensing mechanisms for dispensing portioned food at predetermined times. Some animal feeders are internet connected and allow the user to selectively dispense food on a remote command. Also, some animal feeders are equipped with sensor antennas that can detect microchips that are embedded in tags the animal wears on their collar and others can further detect microchips that are implanted into the pet.

While each of the pet feeders currently available on the market has certain features which are individually effective for their intended purpose, there is always an ongoing need for improved and updated feeding systems.

### SUMMARY OF THE DISCLOSURE

The instant invention relates to an automated animal or pet feeder which has an integrated food hopper and automated food dispensing mechanism which can periodically dispense portioned food over a period of several days or weeks depending on the animal size and food portions. The feeder may further incorporate an infrared (IR) proximity sensor system with a highly sensitive RFID microchip antenna which can sense either external tag microchips or microchips implanted directly within the animal itself.

The subject feeder generally comprises a main housing having an automated food dispensing mechanism in the lower rear portion thereof with a removable food hopper situated immediately above the food dispensing mechanism. Forward of the hopper and dispenser toward the front of the housing is a feeding access area including an upwardly open feed bowl with an access aperture situated above the feed bowl, and a controlled door mechanism which can be selectively extended to close the aperture and prevent feeding or retracted to open the aperture to allow feeding. The feeding access area further includes side walls and a top wall that extend upwardly and forwardly around the feeding access area to define an open frame at the front of the feeder assembly but closed on the rear and sides, i.e. access only from the front opening of the feeder.

The food hopper may have a transparent or translucent hopper for receiving a feed supply to be dispensed. A rotating dispensing mechanism moves food to an open chute at the bottom of the hopper and into a feed chute which leads to the feed bowl.

A segmented roll-top door mechanism is fixed in a track system extending along the feed access area above the feed bowl and may be controlled to extend over the top of the feed bowl to close the feed bowl aperture and prevent feeding or to be retracted into the housing to open the aperture and expose the feed bowl for feeding.

As noted above, individualized pet access may in various modes be controlled by the infrared (IR) sensor system and/or the highly sensitive RFID microchip antenna that can sense either external tag microchips or microchips implanted directly into the animal itself.

Microchip identification codes can be paired with or entered into the feeder system memory to allow access to the feeder depending on selected programming modes. Operation of the access door and providing selective access to an authorized pet may be accomplished by any of a variety of operational modes.

Some prior art operating modes focus on a CLOSED mode presumption. The access door remains closed until a pet with an authorized microchip approaches the feeder. When the microchip is identified as an authorized chip, the door opens to allow feeding. The IR sensor system is used as a safety measure to ensure the door will not close while the pet is still eating, even if the RFID signal briefly drops. However, this CLOSED mode has been found to require training of the pet to recognize that approaching the feeder will open the door even though the food is not visible to the pet. It is often not a viable mode as many pets simply do not adapt to the training. The pets are often spooked by the opening movement of the door upon approach and will not return. This CLOSED operating mode is one of several operating modes that may be available as an option in the present system.

The present system also incorporates a unique OPEN MODE of operation that focuses on keeping the access door open to allow the pet to see that there is food available without startling or spooking the pet with unexpected door movement when approaching.

In an open mode operation, once food is dispensed into the feed bowl, the access door is opened to allow access to the feeder. The microchip antenna loop is active and continuously scanning for a microchip.

If no microchip is detected, the default programming keeps the door open.

If a microchip is detected, the system compares the chip ID to a previously paired ID to determine if the pet is the authorized pet for the feeder. If the microchip ID matches and is authorized, the door remains open, and the antenna loop systems remain active. In this scenario, the authorized pet is not affected and does not even recognize anything other than the food is available.

If the microchip ID does not match (non-paired), the food access door will close and remain closed until the unauthorized pet leaves the feeder.

Once the unauthorized pet leaves the feeder, the system cycles back to the OPEN MODE start position, i.e. no microchip detected and door open. In this manner, the door normally remains open, but the system operates to actively exclude any tagged but unauthorized pets.

As can be appreciated by one skilled in the art, the present system provides a unique combination of automated food dispensing with sensing of both tagged and implanted microchips in an integrated feeder system. These features together with the novel OPEN MODE of operation provide a significant improvement in the art which is believed to have patentable merit.

While embodiments of the invention have been described as having the features recited, it is understood that various combinations of such features are also encompassed by particular embodiments of the invention and that the scope of the invention is limited by the claims and not the description.

### BRIEF DESCRIPTION OF THE DRAWING FIGURES

While the specification concludes with claims particularly pointing out and distinctly claiming particular embodiments of the instant invention, various embodiments of the invention can be more readily understood and appreciated from the following descriptions of various embodiments of the invention when read in conjunction with the accompanying drawings in which:

FIG. 1 is a perspective view of an exemplary embodiment of a pet feeder in accordance with the teachings of the present disclosure;

FIG. 2 is another perspective view thereof with a front frame panel removed to illustrate the location of internal infra-red sensors;

FIGS. 3 and 4 are similar perspective views thereof with the front frame panel removed to illustrate the location of an internal RFID loop antenna;

FIG. 5 is a cross-sectional view of the pet feeder taken along line 5-5 of FIG. 1 illustrating various components of the segmented door panel and motorized drive mechanism;

FIG. 6 is an illustration of an electronic control circuit embodied in the pet feeder to control operation and food access; and

FIG. 7 is a flow chart illustrating an exemplary OPEN MODE method of operation in accordance with the teachings of the present invention.

### DETAILED DESCRIPTION OF EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art will recognize that these terms are merely relative to the system and device being discussed and are not universal.

Unless otherwise specified, when referring to a numerical value, the term “about” is intended to be construed as including a range of values within +/−10% of the value being referred to.

The instant invention relates to an automated animal or pet feeder generally indicated at 10 which has an integrated food hopper 12 and automated food dispensing mechanism 14 which can periodically dispense portioned food over a period of several days or weeks depending on the animal size and food portions. The feeder 10 further incorporates an infrared (IR) sensor 16 system and/or a highly sensitive microchip antenna 18 which can sense animal identification microchips 20, either tagged or implanted directly into the animal itself.

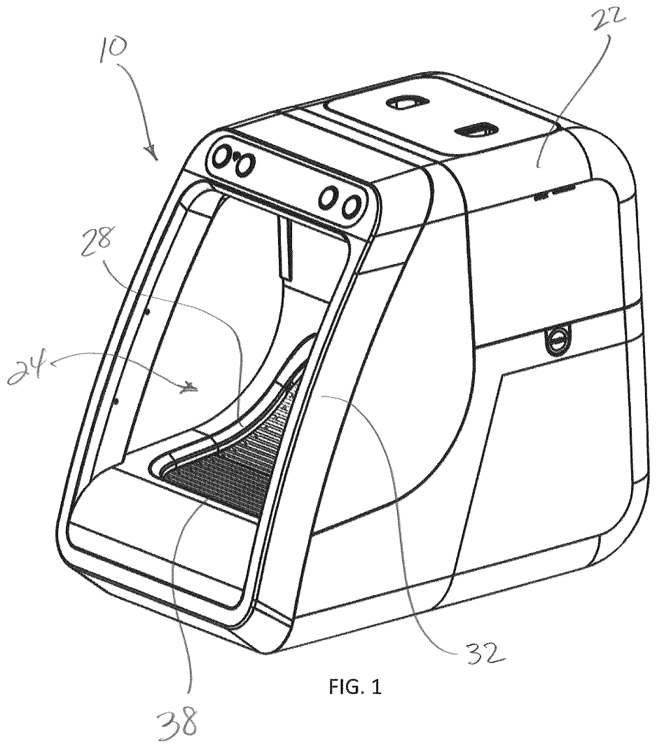

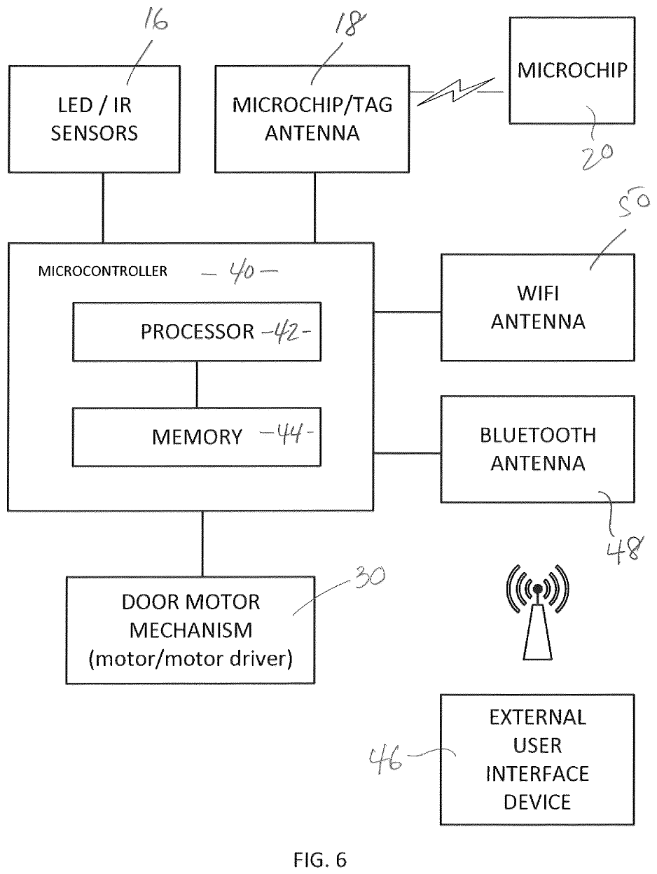

Referring to the attached drawings FIGS. 1-6, the subject feeder 10 generally comprises a main housing 22 having an automated food dispensing mechanism 14 in the lower rear portion thereof with a removable food hopper 12 situated immediately above the food dispensing mechanism. Forward of the hopper 12 and dispenser 14 toward the front of the housing 22 is a feeding access area 24 including an upwardly open feed bowl 26 with an access aperture 28 situated above the feed bowl 26, and a controlled door mechanism generally indicated at 30 which can be selectively extended to close the aperture 28 and prevent feeding, or retracted to open the aperture 28 to allow feeding. The housing surrounding the feeding access area 24 further includes side walls and a top wall that extend upwardly and forwardly around the feeding access area 24 to define an open frame 32 at the front of the feeder assembly.

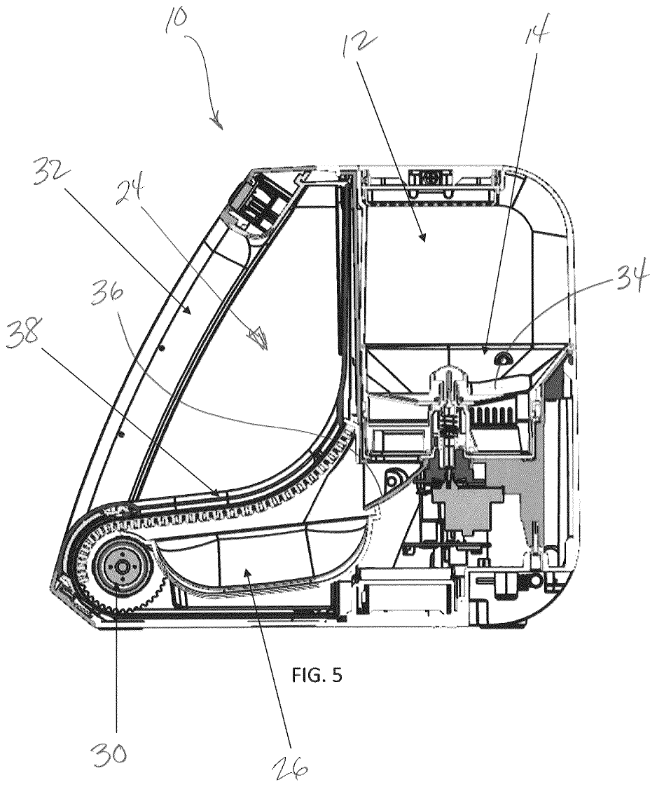

Referring to FIG. 5, the automated dispenser mechanism 14 is relatively conventional in the art. Generally, the dispenser uses a rotating vertical axis sweeper 34 with fixed paddles to move food to an open chute at the bottom of the hopper and into a feed chute 36 which leads to the feed bowl 26. The internal sweeper 34 in the hopper is driven by a motorized drive controlled by conventional motor controllers and microprocessor control system and programming.

It can be noted here that the present feeder may be powered by conventional 120V home with a rechargeable backup battery system. The interior bottom wall of the food hopper may include infrared sensors to detect the food level within the hopper is nearly empty. The dispensing mechanism may also have infrared sensors located at the outlet of the food dispenser to detect if the food dispensing entrance is jammed. As can be appreciated, the sensors are in communication with the feeder microprocessor controls and generate appropriate signals to either an integrated dashboard display on the feeder or wirelessly to an associated application, or both.

Referring to FIGS. 1-5, the door mechanism 30 comprises a segmented roll-top door 38 fixed in a track system extending along the feed access area 24 above the feed bowl 26 and may be controlled to extend over the top of the feed bowl 26 to close the feed bowl aperture 28 and prevent feeding or to be retracted into the housing 22 to open the aperture 28 and expose the feed bowl 26 for feeding.

The door mechanism 30 includes an electric motor and motor driver and is controlled by a microcontroller 40 with a processor 42 and memory 44 programmed to operate the system.

As noted above, individualized pet access may in various operational modes be controlled by the infrared (IR) sensor system 16 and/or with a highly sensitive microchip antenna 18 which can sense either external tag microchips 20 or microchips 20 implanted directly into the animal itself.

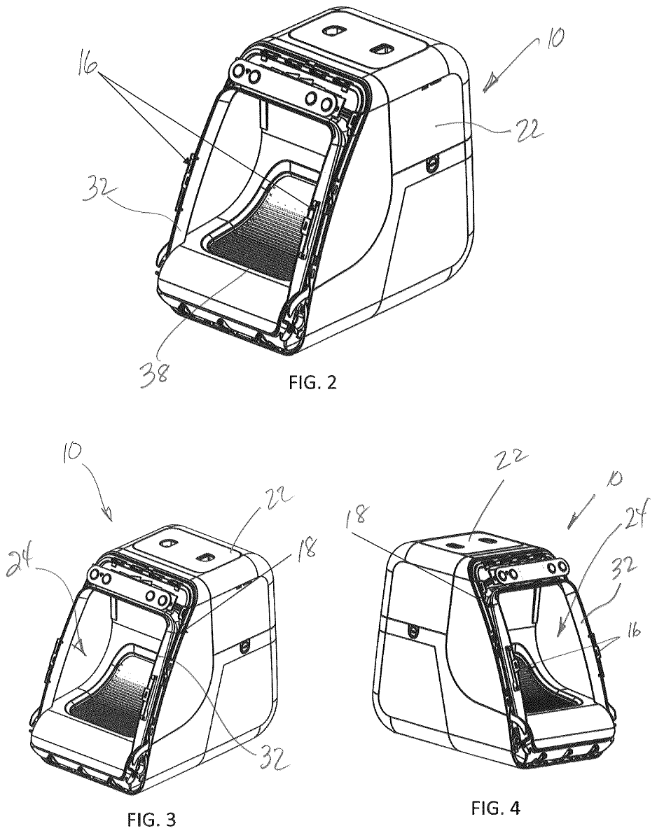

Located within the front side pillars of the frame 32 are two IR sensor arrays 16A, 16B (See FIG. 2). In some modes, the IR sensors 16 are continuously active to detect motion within the feeding access area 24. The antenna loop 18 is extended around the frame 32 so as to activate the microchips as the animals head passes through the frame aperture (See FIGS. 3-4).

Microchip identification codes can be paired with or programmed within the feeder system memory 44 either directly through a manual input on the feeder, or remotely from an associated application running on an external user interface device (phone, tablet, etc.) 46 through Bluetooth 48 or WiFi 50 connections.

Storing the chip ID's in memory will enable the system to either allow access to the animal depending on selected a programming mode. Operation of the access door 38 and providing selective access to an authorized pet may be accomplished by any of a variety of operational modes.

Some prior art operating modes focus on a CLOSED mode presumption. The access door remains closed until a pet with an authorized microchip approaches the feeder. When the microchip is identified as an authorized tag, the door opens to allow feeding. The IR sensor system 16 is used as a safety measure to ensure the door mechanism 30 will not close while the pet is still eating, even if the RFID signal briefly drops. However, this CLOSED mode has been found to require training of the pet to recognize that approaching the feeder will open the door even though the food is not visible to the pet. Further, it is often not a viable option for many pets that simply cannot adapt to the training. The pets are often spooked by the opening movement of the door upon approach and will not return. This CLOSED operating mode is one of several operating modes that may be available as an alternative option in the present system.

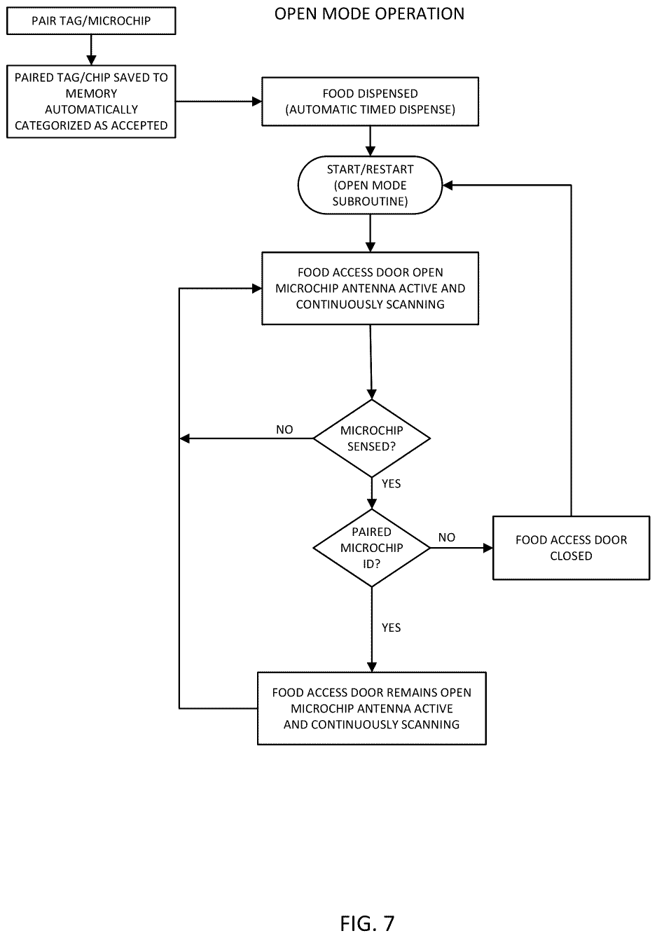

The present system incorporates a unique OPEN MODE of operation that focuses on keeping the access door 38 open to allow the pet to see that there is food available without startling or spooking the pet with unexpected door movement when approaching. Turning to FIG. 7, a flow chart of one example of an OPEN MODE operation is set forth and explained.

### Example 1 (Simple OPEN MODE)

Paired microchip ID with automatic ACCEPT of paired microchip. DENY all other microchip-tagged but unpaired animals.

The pet owner pairs and stores a single pet microchip in the system memory.

OPEN mode operation is illustrated where the system automatically categorizes the single paired microchip as ALLOWED. Essentially, you are pairing only a single ALLOWED microchip. Any unpaired scan compatible microchip will be DENIED.
opening and maintaining the motorized door in a normally open position to allow access to the feed bowl;
(d) scanning for a microchip, wherein
   (e)(1) if a microchip is detected, comparing the scanned microchip ID code with the stored microchip ID, and
   (e)(2)(a) if the scanned microchip ID code matches the stored microchip ID code, maintaining the motorized door open, or
   (e)(2)(b) if the scanned microchip ID code does not match the stored microchip ID code, closing the motorized door.

As can be appreciated by one skilled in the art, the present system provides a unique combination of automated food dispensing with sensing of both tagged and implanted microchips in an integrated feeder system. These features together with the novel OPEN MODE of operation provide a significant improvement in the art which is believed to have patentable merit.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A method of operating a pet feeder apparatus, comprising the steps of:
(a) providing a pet feeder apparatus comprising:
a housing having a feed bowl, a feeding access frame, and a motorized door over the feed bowl,
a microchip antenna on the feeding access frame, and
a control circuit including a processor and memory configured to selectively control the microchip antenna and motorized door;
(b) storing a single microchip identification (ID) code in the control circuit memory;
(c) opening and maintaining the motorized door in a normally open position to allow access to the feed bowl;
(d) scanning for a microchip, wherein
(e)(1) if a microchip is detected, comparing the scanned microchip ID code with the stored microchip ID, and
(e)(2)(a) if the scanned microchip ID code matches the stored microchip ID code, maintaining the motorized door open, or
(e)(2)(b) if the scanned microchip ID code does not match the stored microchip ID code, closing the motorized door.

2. The method of claim 1 further comprising the step of reopening the motorized door after step (e)(2)(b).

3. The method of claim 1 comprises maintaining the microchip antenna loop active at all times.

4. The method of claim 1 further comprising the steps of continuously repeating steps (c) through (e)(2)(b).

5. The method of claim 2 further comprising the steps of continuously repeating steps (c) through (e)(2)(b).

6. The method of claim 3 further comprising the steps of continuously repeating steps (c) through (e)(2)(b).
